(19) United States
(12) Patent Application Publication
(10) Pub. No.: US 2020/0173224 A1
(43) Pub. Date: Jun. 4, 2020

(54) COVER ASSEMBLY FOR WINDOWS

(71) Applicant: HOMAG GMBH, Schopfloch (DE)

(72) Inventor: Volker SCHMIEDER, Mössingen (DE)

(21) Appl. No.: 16/614,093

(22) PCT Filed: May 14, 2018
(86) PCT No.: PCT/EP2018/062324

§ 371 Date: Nov. 15, 2019

(30) Foreign Application Priority Data
May 19, 2017 (DE) 10 2017 208 479.0

(51) Int. Cl. E06B 1/34; E06B 7/14; E06B 3/30; E06B 7/16; E06B 1/56

(52) U.S. Cl. CPC E06B 1/34; E06B 7/14; E06B 1/56; E06B 7/16; E06B 3/307

(57) ABSTRACT

The invention relates to a cover assembly for covering a frame, a frame and an opening frame or two opening frames of at least one window, comprising a first profiled cover which can be secured to the frame or to one of the opening frames and by means of which an outer cladding can be secured. The profiled cover at least partly covers the frame, the frame and the at least one opening frame or the two opening frames, and the outer cladding connected to the profiled cover covers the profiled cover and the frame or the frame and the opening frame or the two opening frames.

### TECHNICAL FIELD

The invention relates to a cover assembly for windows and to a window having a cover assembly.

### PRIOR ART

Windows typically have an outer frame, which is fastened on the building or on the structure. An opening casement having a casement frame and often having a window pane is arranged in a fixed or openable manner in this outer frame. For this purpose, the opening casement is mounted rotatably and/or tiltably on the outer frame by means of fittings.

There is furthermore a frequently known practice, especially in the case of wooden windows, of covering the outer frame and opening frame on the weather side with aluminum profiles or sometimes also plastic profiles, these then also ultimately being referred to, in the case where aluminum profiles are used, as wood-aluminum windows. There is also a known practice, in the case of plastic windows, of covering the outer frame and the opening frame with aluminum profiles on the outside. The overall intention in covering them with aluminum profiles is to increase durability while, at the same time, extending or eliminating maintenance intervals.

More recently, according to another trend, there is a desire to minimize the proportion of a window made up of the frame surface relative to the proportion of the window made up of the pane, thereby making it possible to enlarge the proportion made up of the pane surface, enlarging the area for the entry of light, thereby in principle also increasing the solar energy yield. Moreover, there is a desire among architects, for reasons of appearance, that no frame material of a window frame should be visible on the outside of the façade of a building. The intention is by this means to achieve a uniform modern appearance of the building because, apart from the outer cladding of the building, only the glass of the windows is visible.

A significant additional aspect here is also that the frame material of the window frame may have a negative effect on the thermal insulation value of the window. In some cases, therefore, very large cross sections of wood are required in the depth of the window from the outside to the inside, or window scantlings or the covering shells are provided with additional thermal insulation cores to achieve the desired thermal insulation value in the outer frames or opening frames. However, such integrated insulating materials increase production costs and, depending on the insulating material used, can also increase the cost of the subsequent disposal of the window or make it more difficult. Such windows have been disclosed by DE 101 00 101 C1 and AT 396 385 B, for example.

### DESCRIPTION OF THE INVENTION, PROBLEM, SOLUTION, ADVANTAGES

The problem addressed by the present invention is that of creating a cover assembly for windows and a window having a cover assembly of this kind, which can meet the requirements for weather protection, thermal insulation and a modern appearance and is/are nevertheless of simple construction and can be produced at low cost.

This problem in respect of the cover assembly is solved by the features of claim 1.

One embodiment example of the invention relates to a cover assembly for covering an outer frame, an outer frame and an opening frame, or two opening frames of at least one window, having a first profiled cover, which can be fastened on the outer frame or on one of the opening frames and by means of which an outer cladding can be fastened, wherein the profiled cover at least partly covers the outer frame, the outer frame and the at least one opening frame, or the two opening frames, wherein the outer cladding connected to the profiled cover covers the profiled cover and the outer frame, the outer frame and the opening frame, or the two opening frames. This provides a simple and low-cost cover assembly which enables an outer frame and/or an opening frame, or two opening frames to be covered with a very high-grade appearance. Here, it is possible to use a sheet-like, flat material as an outer cladding with a very high-grade appearance. As an alternative, a three dimensionally shaped material can also be used. As a further alternative, it is also possible to assemble a flat material to achieve a desired shape.

In a preferred embodiment example, it is expedient if the profiled cover has at least one first fastening element and optionally one second fastening element, by means of which the profiled cover can be connected to a frame or to an opening frame. It is thereby possible to provide a permanent and secure connection, especially in the region of the exterior of a building, which also meets the thermal and weather-related requirements in respect of stability, safety and durability.

Thus, it is also advantageous if the first fastening element and optionally the second fastening element is or are arranged on a first lateral end region of the profiled cover. Secure fastening is thereby achieved and there is no interference from other functions since the functions are distributed over the profiled cover.

It is also advantageous if the profiled cover has a third fastening element, by means of which the outer cladding can be connected to the profiled cover. In this way, secure connection to the outer cladding is achieved. Here, the term “outer cladding” is intended to indicate that the cladding is arranged on the outside of the profiled cover, i.e. away from the window. In this case, the outer cladding can be arranged both on an exterior side of a building and on an interior side of a building.

It is also preferred if the third fastening element is arranged on a second lateral end region of the profiled cover. In this way, the fastening of the profiled cover itself is separated spatially from the connection of the outer cladding.

It is also particularly advantageous if the profiled cover has a fourth fastening element and optionally a fifth fastening element, by means of which a first sealing element and optionally a second sealing element can be connected to the profiled cover. It is thereby possible to seal off the window with respect to the outside.

According to another concept according to the invention, it is also advantageous if a fastening profile and/or a second profiled cover are/is furthermore provided. It is thereby possible to fasten an outer cladding in the manner required, such as on a building connection, on an outer frame or on an opening frame or on several outer frames in a bridging manner or on several opening frames in a bridging manner.

It is also advantageous if the fastening profile and/or the second profiled cover have/has at least one first fastening element and one second fastening element. This serves to fasten the fastening profile or the second profiled cover itself and/or to fasten the outer cladding.

Thus, it is also advantageous if the first fastening element of the fastening profile and/or of the second profiled cover serves to connect the fastening profile and/or the second profiled cover to an outer frame or to an opening frame.

It is also advantageous if the second fastening element of the fastening profile and/or of the second profiled cover serves to connect an outer cladding to the fastening profile and/or to the second profiled cover.

It is likewise preferred if at least one of the fastening elements is provided as at least one web and/or at least one pocket. This makes assembly simple and enables the profiled cover and/or the fastening profile to be produced in a simple manner. For example, a profile of this kind can be produced as an extruded profile made of plastic or of metal, e.g. aluminum.

It is also advantageous if the at least one web projects in a lateral direction or in a normal direction, wherein the lateral direction lies in a plane which is defined by the window surface of the window and the normal direction is aligned perpendicularly to the window surface. This allows secure fastening, especially if one web projects in the lateral direction and a second web in a normal direction. Thus, fastening diagonally on an outer frame or on an opening frame or in some other way would be possible.

It is also advantageous if the window surface is defined by a pane or by an insert which is arranged in an outer frame or in an opening frame.

It is also advantageous if the at least one pocket is of open design in a lateral direction or in a normal direction. It would thereby also be possible to achieve secure and space-saving fastening, especially of the outer cladding.

It is furthermore expedient if a filling and/or insulating material is arranged between the outer cladding and the outer frame and/or the opening frame and/or the profiled cover and/or the fastening profile. This makes it easier to comply with energy parameters on the building and excessively large cavities, which are in many respects disadvantageous, would not be formed.

It is also advantageous if the outer cladding has an element which is aligned substantially normally to the window surface and by means of the extent of which the space for a filling and/or insulating material can be specified.

The outer cladding can advantageously be composed of one of the following materials or mixtures or compositions thereof: metal, aluminum, plastic, wood and/or glass. This may advantageously also be considered to be an independent invention which could be interpreted independently of the features of independent claim 1.

It is furthermore advantageous if the profiled cover has openings, such as holes or slots or the like, for draining water, such as condensate and/or rainwater. This may advantageously also be considered to be an independent invention which could be interpreted independently of the features of independent claim 1.

The problem in respect of the window having a cover assembly is solved by the features of claim 19.

An embodiment example of the invention relates to a window, in particular a window having an outer frame and/or, in particular, having at least one opening frame, wherein a cover assembly as claimed in any one of the preceding claims is provided.

It is particularly advantageous if a drainage device is integrated into the outer cladding and/or into at least one profiled cover in order to enable water that arises to be drained out of the outer cladding and/or out of the at least one profiled cover.

Thus, it is expedient if the drainage device has at least one tube, which is let into the outer cladding and/or into at least one profiled cover and carries water out of the outer cladding and/or out of the at least one profiled cover.

The invention also advantageously relates to a window, in particular a window having an outer frame and/or, in particular, having at least one opening frame, wherein an additional element is inserted into or connected to the outer frame and/or the opening frame in order to increase the stability of the outer frame and/or of the opening frame. This is advantageous particularly if the dimensions of the profile of the outer frame and/or of the opening frame are reduced to give a narrow appearance.

It is also advantageous here if the additional element is a reinforcing profile, which is preferably composed of metal and is connected to the outer frame and/or to the opening frame and, in particular, is inserted into a recess in the outer frame and/or in the opening frame. This may advantageously also be considered to be an independent invention which could be interpreted independently of the features of independent claim 19.

Further advantageous embodiments are described by the following description of the figures and by the dependent claims.

### BRIEF DESCRIPTION OF THE FIGURES OF THE DRAWING

The invention is explained in greater detail below on the basis of at least one illustrative embodiment with reference to the figures of the drawing. In the drawing:

FIG. 1 shows a view of a partial section through a cover assembly of a window in a housing opening in accordance with a first embodiment example of the present invention,

FIG. 2 shows a view of a partial section through a cover assembly of a window in a housing opening in accordance with a second embodiment example of the present invention,

FIG. 3 shows a view of a partial section through a cover assembly of a window in a housing opening in accordance with a third embodiment example of the present invention,

FIG. 4 shows a view of a partial section through a cover assembly of a window in a housing opening in accordance with a fourth embodiment example of the present invention,

FIG. 5 shows a view of a partial section through a cover assembly of a window in a housing opening in accordance with a fifth embodiment example of the present invention,

FIG. 6 shows a view of a partial section through a cover assembly of a window in a housing opening in accordance with a sixth embodiment example of the present invention,

FIG. 7 shows a view of a partial section through a cover assembly of a window in a housing opening in accordance with a seventh embodiment example of the present invention,

FIG. 8 shows a view of a partial section through a cover assembly of a window, in particular in a housing opening, in accordance with an eighth embodiment example of the present invention,

FIG. 9 shows a view of a partial section through a cover assembly of a window, in particular in a housing opening, in accordance with a ninth embodiment example of the present invention,

FIG. 10 shows a view of a partial section through a cover assembly of a window, in particular in a housing opening, in accordance with a tenth embodiment example of the present invention,

FIG. 11 shows a view of a partial section through a cover assembly of a window, in particular in a housing opening, in accordance with an eleventh embodiment example of the present invention,

FIG. 12 shows a view of a partial section through a cover assembly of a window, in particular in a housing opening, in accordance with a twelfth embodiment example of the present invention,

FIG. 13 shows a view of a partial section through a cover assembly of a window, in particular in a housing opening, in accordance with a thirteenth embodiment example of the present invention,

FIG. 14 shows a view of a partial section through a cover assembly of a window in accordance with a fourteenth embodiment example of the present invention,

FIG. 15 shows a view of a partial section through a cover assembly of a window in accordance with a fifteenth embodiment example of the present invention, and

FIG. 16 shows a view of a partial section through a cover assembly of a window in accordance with a sixteenth embodiment example of the present invention.

### PREFERRED EMBODIMENT OF THE INVENTION

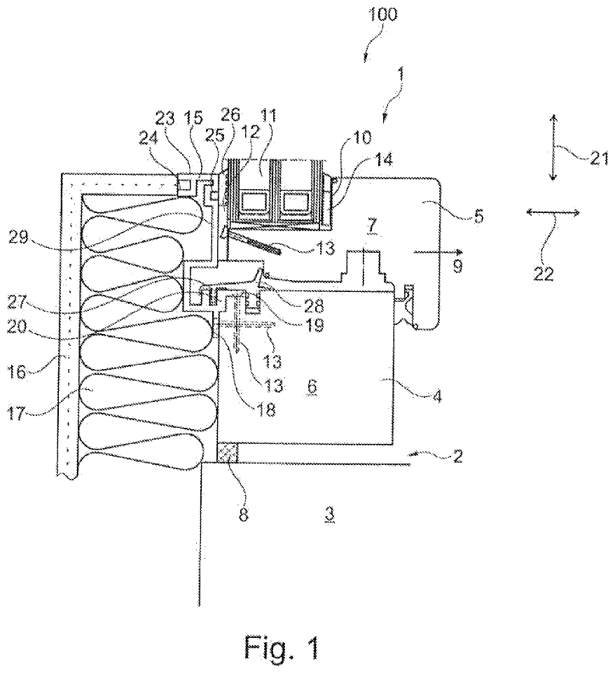

FIG. 1 shows a view of a partial section through a cover assembly of a window 1 in an opening 2, in particular of a building 3, in accordance with a first embodiment example of the present invention. The window 1 is arranged in the opening 2 of a building 3. The window 1 can also be arranged elsewhere without restricting the general scope. In FIG. 1, only part of the building 3, of the opening 2 and of the window 1 can be seen of this assembly in section.

The window 1 has an outer frame 4, which is arranged in the opening 2 of the building 3 and is connected in a fixed manner to the building 3 in order to position the window 1 in a sealed manner in the opening 2 of the building. To seal off the window 1 with respect to the building 3, a sealing element 8 is provided, which rests in a sealing manner both against the outer frame 4 and against the housing in an interspace between the outer frame 4 and the housing 3. The outer frame 4 is formed by outer frame profiles 6, which are connected to one another and form the outer frame 4 as a frame-type element.

The window 1 also has an opening frame 5, which is arranged in the outer frame 4. For this purpose, the opening frame 5 can be arranged movably in the outer frame 4, in particular can be arranged tiltably and/or pivotably and/or slidably. In the present embodiment example in FIG. 1, it is assumed, without restricting the general scope, that the outer frame 4 is of fixed design and the opening frame 5 can be pivoted to the right, see arrow 9. The opening frame 5 is formed by opening frame profiles 7, which are connected to one another and form the opening frame 5 as a frame-type element.

It is advantageous if the outer frame profiles 6 of the outer frame 4 and/or the opening frame profiles 7 of the opening frame 5 are made of wood, plastic, metal, such as aluminum or the like, or of any combination of such materials or from mixtures of such materials in the form of hybrid or composite materials. Reinforcing additions, such as fiber components, cores etc., may also be provided.

The opening frame 5 has a recess 10, which is open on one side for insertion of a pane 11, which is held in the recess 10 by means of the holding element 12. For this purpose, the holding element 12 is screwed to the opening frame 5, for example, see the screw 13. The pane 11 is arranged in a manner sealed with respect to the opening frame 5, for which purpose a seal 14 is provided between the pane 11 and the opening frame 5.

Arranged on the outside of the outer frame 4 is a profiled cover 15, which is firmly connected to the outer frame and extends laterally from the outer frame 4, via the opening frame 5, to an edge region of the pane 11 and likewise covers this edge region of the pane 11.

Visible in FIG. 1 is part of an external outer cladding 16, e.g. plaster, board material or the like, which overlaps the top surface of the profiled cover 15, in particular preferably the entire top surface of the profiled cover 15. The external outer cladding 16 also preferably contains optional thermal insulation 17. In this case, the thickness of the thermal insulation 17 and optionally also the material of the thermal insulation can preferably be selected independently of the profiled cover 15 used.

The profiled cover 15 is configured in such a way that it has at least one fastening element 18 in one of its two lateral end regions 20, in the present embodiment example the profiled cover 15 has two fastening elements 18, in the lateral end region 20. However, it is also possible for more than two such fastening elements 18, 19 to be provided. The fastening element or fastening elements 18, are used to fasten the profiled cover 15 on the outer frame 4. FIG. 1 shows that fastening element 18 is a web which extends in the lateral direction and which is screwed to the outer frame by means of a screw 13. FIG. 1 also shows that fastening element 19 is a web which extends in the normal direction and which is screwed to the outer frame by means of a screw 13.

Here, the lateral direction 21 is defined as the direction which is parallel to the plane of the pane 11. The normal direction 22 is defined as the direction which is aligned perpendicularly to the plane of the pane 11.

In this case, fastening element 18 is perpendicular to fasting element 19, thus enabling the two fastening elements 18, 19 to be screwed on in one corner of the outer frame 4. As an alternative to screw fastening, it is also possible to use some other connection method, e.g. riveting, clipping or adhesive bonding etc. For this purpose, correspondingly suitable connection elements can be used instead of the screws 13 illustrated.

A further, third fastening element 24, which is used to fasten an outer cladding 16, for example, is provided in the other lateral end region 23. Here, the third fastening element 24 is designed as a pocket, which is of open design on one side in the normal direction 22. An element of the outer cladding or a fastening element, for example, can engage in this pocket in order to fasten the outer cladding. The pocket is preferably a groove in the profiled cover 15.

A fourth fastening element 25, which is used to fasten a sealing element 26, for example, is provided adjacent to the third fastening element 24. Here, the fourth fastening element 25 is designed as a pocket, which is of open design on one side in the normal direction 22 and is of open design toward the pane 11. An element of the sealing element 26, for example, can engage in this pocket in order to fasten the sealing element 26 on the profiled cover 15. This pocket is preferably a groove in the profiled cover 15. The sealing element 26 serves to rest against the pane 11 when the window is closed.

A fifth fastening element 27, which is used to fasten a sealing element 28, for example, is furthermore provided in the first lateral end region 20. Here, the fifth fastening element 27 is designed as a pocket, which is of open design on one side in the lateral direction 21 and is of open design toward the opening frame 5. An element of the sealing element 28, for example, can engage in this pocket in order to secure the sealing element 28 on the profiled cover 15. This pocket is preferably a groove in the profiled cover 15. The sealing element 28 serves to rest against the outer frame 4 and against the opening frame 5 when the window is closed.

A straight section 29 of the profiled cover 15, which is arranged opposite the holding element 12 and covers the latter, is provided between the fourth fastening element 25 and the fifth fastening element 27.

The outer cladding 16, together with the profiled cover 15, covers the entire window frame with the outer frame 4 and the opening frame 5 when viewed from the outside, with the result that, when viewed from the outside, the building 3 is provided with windows which are installed without visible frames.

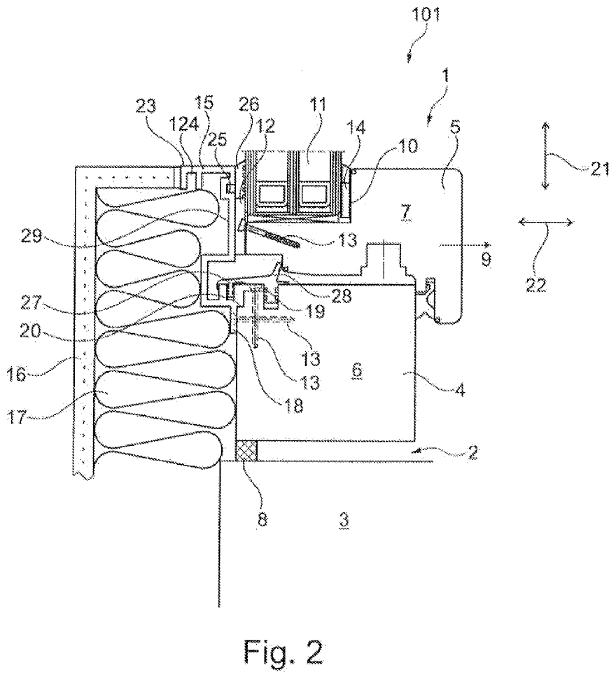

FIG. 2 shows another embodiment example of a cover assembly 101 according to the invention, wherein the cover assembly 101 in FIG. 2 is substantially identical to the cover assembly 100 in FIG. 1, wherein there are modifications in the embodiment example in FIG. 2 in respect of the third fastening element 24 in FIG. 1. The other features in FIG. 2 are the same as in the embodiment example in FIG. 1, and therefore attention is drawn to the description relating thereto.

The third fastening element 124, which is arranged in the other lateral end region 23 and is used to fasten an outer cladding 16, for example, is likewise designed as a pocket but is of open design on one side in the lateral direction 21. An element of the outer cladding 16 or a fastening element, for example, can engage on or in this pocket in order to fasten the outer cladding 16. The pocket is preferably a groove in the profiled cover 15. In FIG. 2, it can be seen that an end section of the outer cladding 16 rests against the outside of the pocket of the fastening element 124 and is adhesively bonded there, for example.

The profiled covers 15 are accordingly configured in such a way that an end profile or a receiving profile, i.e. an open fastening element 24, 124 as a receptacle or as a bearing surface, is provided for this purpose in the end region of the overlap.

The outer claddings can be fastened on the profiled cover 15 of the outer frame 4 in various ways, being screwed or clipped etc., for example. The profiled cover 15 can preferably be fastened on the outside of the outer frame 4 or of the outer frame profile 6 or from the inside thereof. Fastening on the outside has the advantage that manufacturing tolerances do not weigh as heavily. Fastening on the inside has the advantage that additional regions of the outer frame profile 6 can be protected against moisture. As a result, the illustrated seal 28 would not have to project so far outward and the profiled cover could possibly also be of simpler configuration.

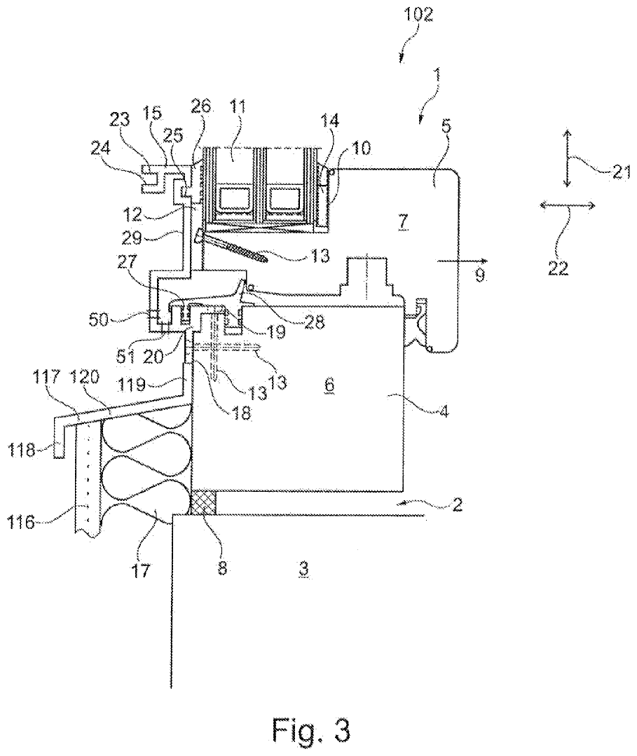

FIG. 3 shows another embodiment example of a cover assembly 102 according to the invention, wherein the cover assembly 102 in FIG. 3 is substantially identical to the cover assembly 100 in FIG. 1, wherein there are modifications in the embodiment example in FIG. 3 in respect of the arrangement of the outer cladding 16 in FIG. 1. The other features in FIG. 3 are the same as in the embodiment example in FIG. 1, and therefore attention is drawn to the description relating thereto.

Visible in FIG. 3 is part of an external outer cladding 116, e.g. plaster, board material or the like, which laterally adjoins the top surface of the profiled cover 15. Here, the outer cladding has an end profile 117 which is of approximately double-L-shaped design and two laterally projecting webs 118, 119, which bound a central web 120. The end profile 117 covers the outer cladding 116 at the side, wherein the end profile 117 is arranged in such a way with the web 119 that the web 119 is arranged on the outer frame 4 as a lateral extension of fastening element 18 and is preferably fastened to said frame there. The external outer cladding 116 also preferably contains optional thermal insulation 17. In this case, the thickness of the thermal insulation 17 and optionally also the material of the thermal insulation can preferably be selected independently of the profiled cover 15 used.

The lower building connection can be embodied as per FIG. 3. Here, in different ways, a body that covers the outer cladding 116 as an end profile 117, e.g. an aluminum profile, e.g. as a windowsill, is attached in the lower region of the profiled cover 15, ensuring that water that collects within the profiled cover 15 can be carried away to the outside on the surface of the covering body. This can be accomplished, for example, by means of a hole or milled slot formed in the profiled cover.

FIG. 3 shows two such holes or slots 50, 51, through which water can escape in accordance with the arrangement of such holes or slots 50, 51. Thus, for example, it is possible for just the hole or the slot 50 to be provided or just the hole or the slot 51 or both. Hole or slot 50 opens in a normal direction parallel to the direction 22. Hole or slot 51 opens in a lateral direction parallel to the direction 21. FIG. 3 shows the opening frame and the outer frame on the underside of the window frame, and therefore direction 21 is aligned in a vertical direction. Direction 22 would then be a horizontal direction. This means that hole or slot 50 or a plurality thereof extends in a horizontal direction and hole or slot 51 or a plurality thereof extends in a vertical direction.

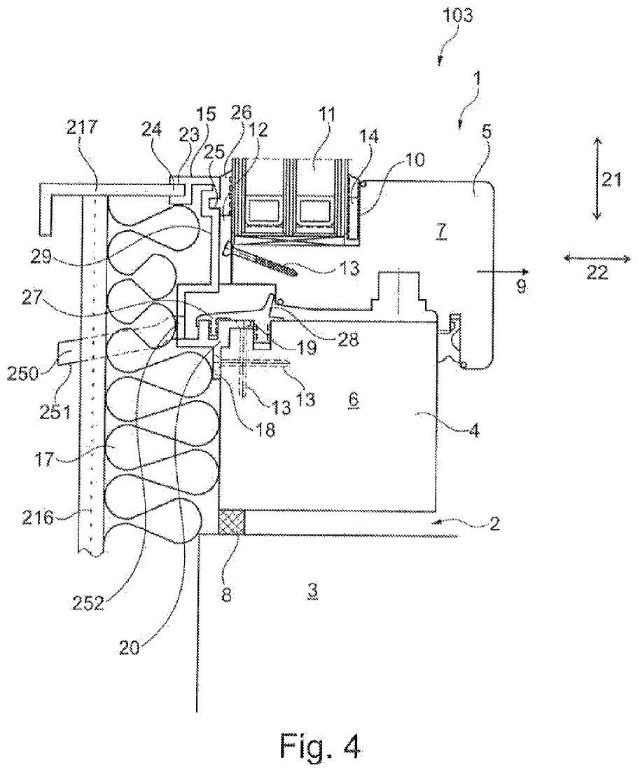

FIG. 4 shows another embodiment example of a cover assembly 103 according to the invention, wherein the cover assembly 103 in FIG. 4 is substantially identical to the cover assembly 100 in FIG. 1, wherein there are modifications in the embodiment example in FIG. 4 in respect of the arrangement of the outer cladding 16 in FIG. 1. The other features in FIG. 4 are the same as in the embodiment example in FIG. 1, and therefore attention is drawn to the description relating thereto.

Visible in FIG. 4 is part of an external outer cladding 216, e.g. plaster, board material or the like, which overlaps the top surface of the profiled cover 15, in particular preferably the entire top surface of the profiled cover 15. In this case, the outer cladding 216 is terminated or covered by an L-shaped end profile 217. The external outer cladding 216 also preferably contains optional thermal insulation 17. In this case, the thickness of the thermal insulation 17 and optionally also the material of the thermal insulation can preferably be selected independently of the profiled cover 15 used.

The L-shaped end profile 217 engages in normal direction 22 in the fastening element 24, which is designed as a pocket, and is preferably fastened there. The end profile 217 covers the outer cladding 216 at the side.

A lower building connection can be embodied as per FIG. 4 in a manner similar to the embodiment of an upper and/or of a lateral building connection. That is to say that the outer cladding 216 overlaps the profiled cover. An end profile 217 for the outer cladding 216 is likewise to be recommended here.

FIG. 4 furthermore shows a drainage device 250, which comprises at least one tube 251 or a plurality of tubes 251 and a hole 252 or a plurality of holes 252 in the profiled cover 15, by means of which water can be drained from the profiled cover 15. For this purpose, the tube 251 is positioned as a continuation of the hole 252 or a respective tube 251 of the tubes is positioned as a continuation of in each case one hole 252 of the holes. The tubes 251 can also form a channel system.

The water which arises can be drained off via the tube 251 or via the tubes 251, which can be let into the outer cladding 216 in corresponding fashion. These can lead directly to the outer surface of the outer cladding 216, can be routed along the window 1 and/or the house wall and can be passed out of the outer cladding 216 at some other point. They can also be laid in other bodies, e.g. tubes.

Such an embodiment can advantageously have the effect that the same advantages can come into play as with the lateral and upper structure connection, especially as regards the thermal insulation and external appearance of the window.

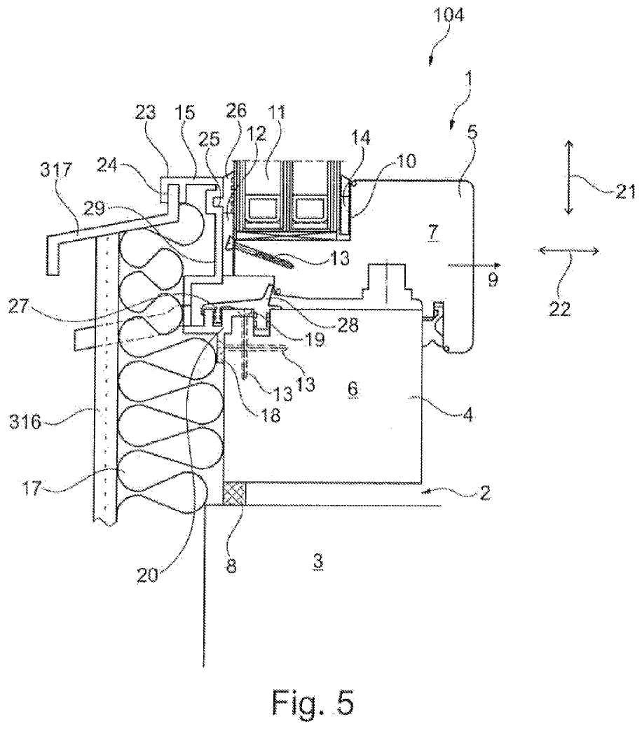

FIG. 5 shows another embodiment example of a cover assembly 104 according to the invention, wherein the cover assembly 104 in FIG. 5 is substantially identical to the cover assembly 100 in FIG. 1 and the cover assembly 101 in FIG. 2, wherein there are modifications in the embodiment example in FIG. 5 in respect of the arrangement of the outer cladding 16 in FIG. 1. The other features in FIG. 5 are the same as in the embodiment example in FIG. 1 and FIG. 2, and therefore attention is drawn to the description relating thereto.

Visible in FIG. 5 is part of an external outer cladding 316, e.g. plaster, board material or the like, which overlaps the top surface of the profiled cover 15, in particular preferably the entire top surface of the profiled cover 15. In this case, the outer cladding 316 is terminated or covered by a double-L-shaped end profile 317. The external outer cladding 316 also preferably contains optional thermal insulation 17. In this case, the thickness of the thermal insulation 17 and optionally also the material of the thermal insulation can preferably be selected independently of the profiled cover 15 used.

The double-L-shaped end profile 317 engages in lateral direction 21 in the fastening element 24, which is designed as a pocket, and is preferably fastened there. The end profile 317 covers the outer cladding 316 at the side.

A lower building connection can be embodied as per FIG. 5 in a manner similar to the embodiment of an upper and/or of a lateral building connection. That is to say that the outer cladding 316 overlaps the profiled cover. An end profile 317 for the outer cladding 316 is likewise to be recommended here.

In a manner similar to the embodiment example in FIG. 4, the water which arises can also be drained off via at least one tube or tubes, which can be let into the outer cladding 316 and is/are positioned in the profiled cover as an extension of holes or slots or the like, for example. This tube or these tubes can lead directly to the outer surface of the outer cladding 316, can be routed along the window 1 and/or the house wall and can be passed out of the outer cladding 316 at some other point. They can also be laid in other bodies, e.g. tubes.

Such an embodiment can advantageously have the effect that the same advantages can come into play as with the lateral and upper structure connection, especially as regards the thermal insulation and external appearance of the window.

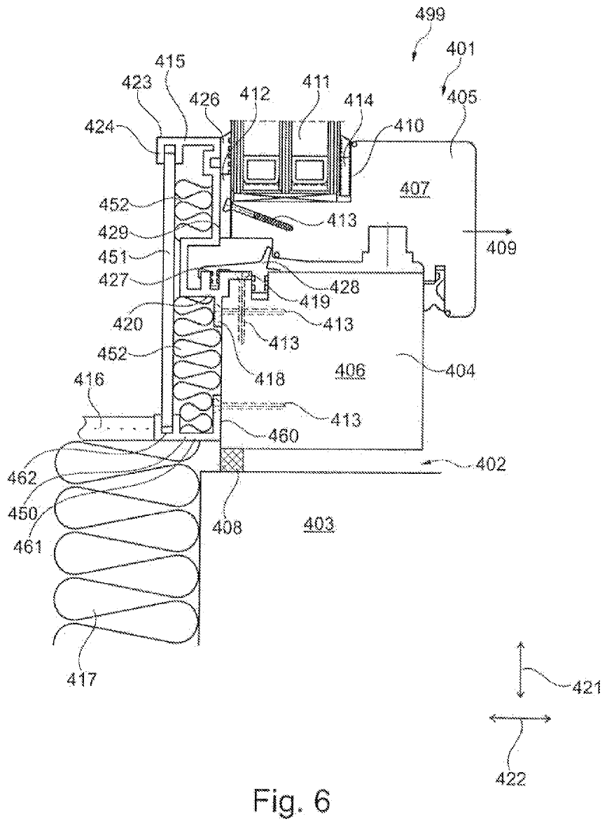

FIG. 6 shows a view of a partial section through another cover assembly 499 according to the invention of a window 401 in an opening 402, in particular of a building 403, in accordance with another embodiment example of the present invention. The window 401 is arranged in the opening 402 of a building 403. The window 401 can also be arranged elsewhere without restricting the general scope. In FIG. 6, only part of the building 403, of the opening 402 and of the window 401 can be seen of this assembly in the section.

The window 401 has an outer frame 404, which is arranged in the opening 402 of the building 403 and is connected in a fixed manner to the building 403 in order to position the window 401 in a sealed manner in the opening 402 of the building. To seal off the window 401 with respect to the building 403, a sealing element 408 is provided, which rests in a sealing manner both against the outer frame 404 and against the building 403 in an interspace between the outer frame 404 and the building 403. The outer frame 404 is formed by outer frame profiles 406, which are connected to one another and form the outer frame 404 as a frame-type element.

The window 401 also has an opening frame 405, which is arranged in the outer frame 404. For this purpose, the opening frame 405 can be arranged movably in the outer frame 404, in particular can be arranged tiltably and/or pivotably and/or slidably. In the present embodiment example in FIG. 6, it is assumed, without restricting the general scope, that the outer frame 404 is of fixed design and the opening frame 405 can be pivoted to the right, see arrow 409. The opening frame 405 is formed by opening frame profiles 407, which are connected to one another and form the opening frame 405 as a frame-type element.

It is advantageous if the outer frame profiles 406 of the outer frame 404 and/or the opening frame profiles 407 of the opening frame are made of wood, plastic, metal, such as aluminum or the like, or of any combination of such materials or from mixtures of such materials in the form of hybrid or composite materials. Reinforcing additions, such as fiber components, cores etc., may also be provided.

The opening frame 405 has a recess 410, which is open on one side for insertion of a pane 411, which is held in the recess 410 by means of the holding element 412. For this purpose, the holding element 412 is screwed to the opening frame 405, for example, see the screw 413. The pane 411 is arranged in a manner sealed with respect to the opening frame 405, for which purpose a seal 414 is provided between the pane 411 and the opening frame 405.

Arranged on the outside of the outer frame 404 is a profiled cover 415, which is firmly connected to the outer frame 404 and extends laterally from the outer frame 404, via the opening frame 405, to an edge region of the pane 411 and likewise covers this edge region of the pane 411.

A fastening profile 450, which is likewise connected in a fixed manner to the outer frame 404, see the screw 413, is furthermore arranged at a distance from the profiled cover 415.

Visible in FIG. 6 is part of an external outer cladding 416, e.g. plaster, board material or the like, which extends as far as the fastening profile 450 and is connected thereto. An outer cladding 451 is furthermore arranged between the profiled cover 415 and the fastening profile 450, said outer cladding substantially covering both the profiled cover 415 and the fastening profile 450. Here, the outer cladding 451 is preferably designed as a board. Optional thermal insulation 452 is arranged between the outer cladding 451 and the profiled cover 415 and between the outer cladding 451 and the outer frame. The external outer cladding 416 also preferably contains optional thermal insulation 417. In this case, the thickness of the thermal insulation 417, 452 and optionally also the material of the thermal insulation can preferably be selected independently of the profiled cover 415 used.

The profiled cover 415 is configured in such a way that it has at least one fastening element 418 in one of its two lateral end regions 420, in the present embodiment example the profiled cover 415 has two fastening elements 418, 419 in the lateral end region 420. However, it is also possible for more than two such fastening elements 418, 419 to be provided. The fastening element or fastening elements 418, 419 are used to fasten the profiled cover 415 on the outer frame 404. FIG. 6 shows that fastening element 418 is a web which extends in the lateral direction 421 and which is screwed to the outer frame by means of a screw 413. FIG. 6 also shows that fastening element 419 is a web which extends in the normal direction 422 and which is screwed to the outer frame by means of a screw 413.

Here, the lateral direction 421 is defined as the direction which is parallel to the plane of the pane 411. The normal direction 422 is defined as the direction which is aligned perpendicularly to the plane of the pane 411.

In this case, fastening element 418 is perpendicular to fasting element 419, thus enabling the two fastening elements 418, 419 to be screwed on in one corner of the outer frame 404. As an alternative to screw fastening, it is also possible to use some other connection method, e.g. riveting, clipping or adhesive bonding etc. For this purpose, correspondingly suitable connection elements can be used instead of the screws illustrated.

A further, third fastening element 424, which is used to fasten the outer cladding 451, for example, is provided in the other lateral end region 423. Here, the third fastening element 424 is designed as a pocket, which is of open design on one side in the lateral direction 421. An element or section of the outer cladding 451 or a fastening element, for example, can engage in this pocket in order to fasten the outer cladding 451. The pocket is preferably a groove in the profiled cover 415.

The further fastening profile 450 is of substantially L-shaped design with a laterally extending first arm 460 and with a normally extending second arm 461. A fastening element 462, which is used to fasten an outer cladding 451, for example, is provided on the second arm 461. Here, the fastening element 462 is designed as a pocket, which is of open design on one side in the lateral direction 421 and is of open design toward the fastening element 424. An element or section of the outer cladding 451, for example, can engage in this pocket in order to fasten the outer cladding between the fastening elements 424 and 462. This pocket is preferably a groove in the fastening profile 450.

A fifth fastening element 427, which is used to fasten a sealing element 428, for example, is furthermore provided in the first lateral end region 420 of the profiled cover 415. Here, the fifth fastening element 427 is designed as a pocket, which is of open design on one side in the lateral direction 421 and is of open design toward the opening frame 405. An element of the sealing element 428, for example, can engage in this pocket in order to fasten the sealing element 428 on the profiled cover 415. This pocket is preferably a groove in the profiled cover 415. The sealing element 428 serves to rest against the outer frame 404 and against the opening frame 405 when the window is closed.

A straight section 429 of the profiled cover 415, which is arranged opposite the holding element 412 and covers the latter, is provided between the fourth fastening element 425 and the fifth fastening element 427.

The outer claddings 416 and 451, together with the profiled cover 415, cover the entire window frame with the outer frame 404 and the opening frame 405 when viewed from the outside, with the result that, when viewed from the outside, the building 403 is provided with windows which are installed without visible frames.

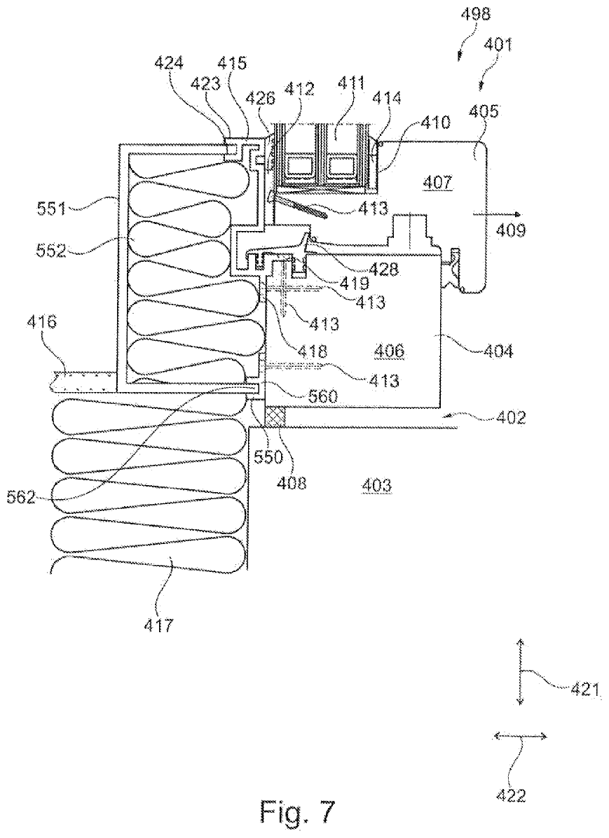

FIG. 7 shows a view of a partial section through another cover assembly 498 according to the invention of a window 401 in an opening 402, in particular of a building 403, in accordance with another embodiment example of the present invention. The embodiment example in FIG. 7 is substantially similar to the embodiment example in FIG. 6, and reference can very largely be paid to the description in this respect and essentially only the differences are explained below.

A fastening profile 550, which is connected in a fixed manner to the outer frame 404, see the screw 413, is arranged at a distance from the profiled cover 415.

Visible in FIG. 7 is part of an external outer cladding 416, e.g. plaster, board material or the like, which extends as far as an outer cladding 551 and is connected thereto. This further outer cladding 551 is arranged between the profiled cover 415 and the fastening profile 550, said outer cladding substantially covering both the profiled cover 415 and the fastening profile 550. The further outer cladding 551 is designed as a U-shaped profile. Optional thermal insulation 552 is arranged between the further outer cladding 551 and the profiled cover 415 and between the further outer cladding 551 and the outer frame 404. The external outer cladding 416 also preferably contains optional thermal insulation 417. In this case, the thickness of the thermal insulation 417, 552 and optionally also the material of the thermal insulation can preferably be selected independently of the profiled cover 415 used.

A further, third fastening element 424, which is used to fasten the outer cladding 551, is provided in the other lateral end region 423. Here, the third fastening element 424 is designed as a pocket, which is of open design on one side in the normal direction 422. An element or section of the outer cladding 551 or a fastening element, for example, can engage in this pocket in order to fasten the outer cladding 551. The pocket is preferably a groove in the profiled cover 415.

The further fastening profile 550 is of substantially F-shaped design with a laterally extending first arm 560. A fastening element 562, which is used to fasten an outer cladding 551, for example, is provided on the arm 560. Here, the fastening element 562 is designed as a pocket, which is of open design on one side in the normal direction 422. An element or section of the outer cladding 551, for example, can engage in this pocket in order to fasten the outer cladding between the fastening elements 424 and 562. This pocket is preferably a groove in the fastening profile 550.

FIGS. 6 and 7 show profiled covers, each having an additional fastening profile for an outer cladding. Here, the outer cladding can be composed of various, individually selected materials, e.g. metal, plastic, wood and/or glass.

The outer cladding is preferably held by means of the profiled cover and the at least one further fastening profile. In this case, the outer cladding can optionally also extend only in the region of the window profiles and can optionally also be continued beyond the wall connection. A filling and/or insulating material can be inserted underneath the outer cladding, i.e. on the inside of the outer cover.

In principle, the choice of filling and/or insulation material in each embodiment example can be made according to the specific requirements.

The embodiment example in FIG. 6 has the advantage that only a flat, sheet-like outer cladding is required, and this can be produced in a simple and low-cost manner. As an alternative, however, a three dimensionally modeled outer cladding can also be used. The embodiment example in figure has the advantage that there is substantial freedom of choice as regards the thickness and configuration of the outer cladding. In particular, it is thereby possible to adapt the thickness of the thermal insulation 552, for example, e.g. to legal requirements.

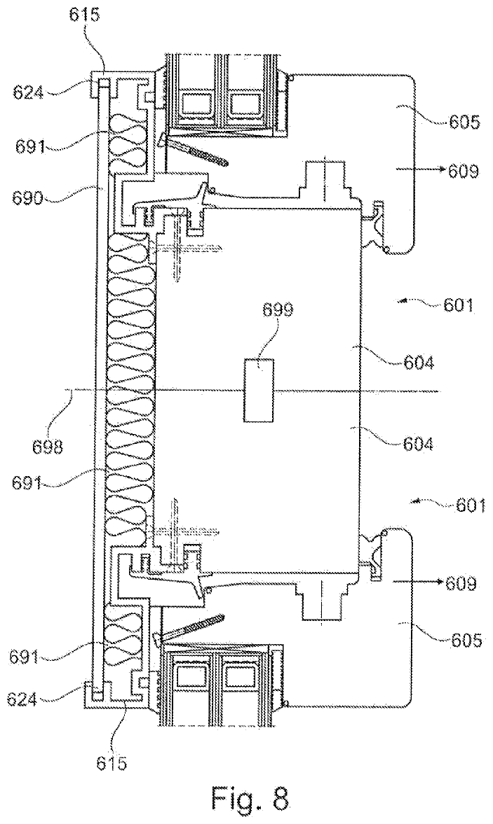

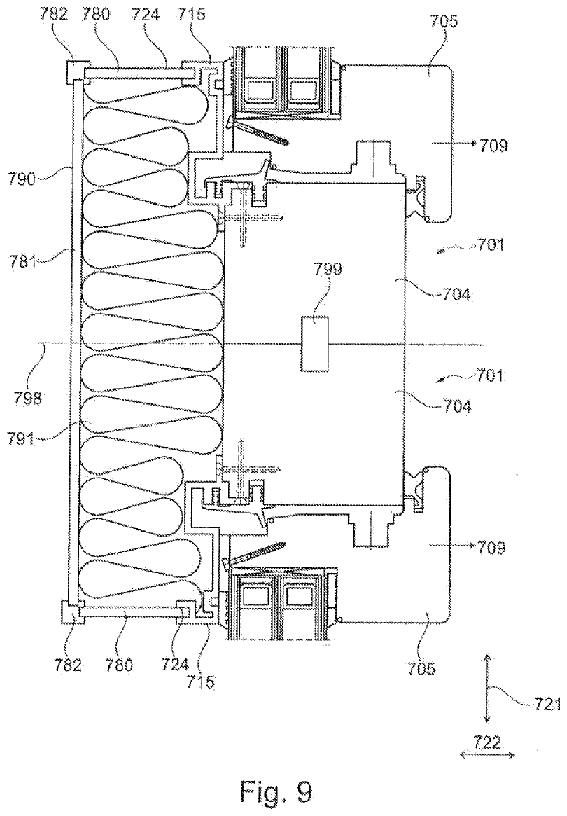

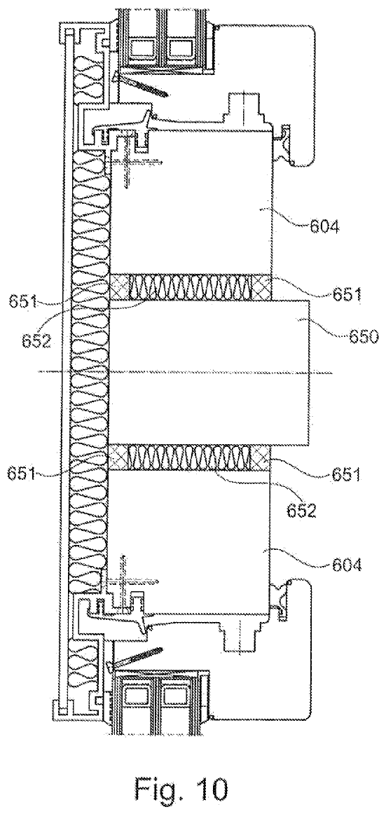

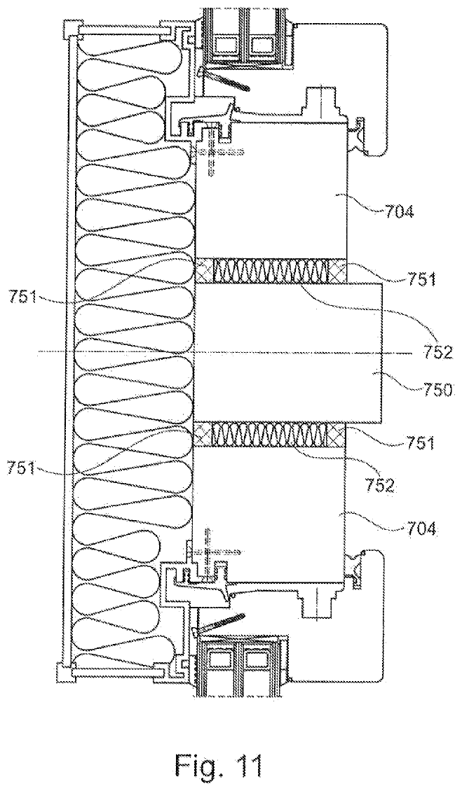

FIGS. 8 to 11 show further embodiment examples, in which two windows are arranged adjacent to one another, wherein the embodiment examples in FIGS. 8 and 9 are formed symmetrically with respect to a mirror plane between two adjacent outer frames and wherein the embodiment examples in FIGS. 10 and 11 are formed symmetrically with respect to a mirror plane, in which the mirror plane lies centrally in a profile which is arranged between the two outer frames. In this case, the embodiment example in figure corresponds to a symmetrical arrangement of two windows similar to FIG. 6. Moreover, the embodiment example in FIG. 9 corresponds to a symmetrical arrangement of two windows similar to FIG. 7. In this case, the embodiment example in FIG. 10 corresponds to a symmetrical arrangement of two windows with a profile arranged in between, similar to FIG. 6. Moreover, the embodiment example in FIG. 11 corresponds to a symmetrical arrangement of two windows with a profile arranged in between, similar to FIG. 7.

FIG. 8 shows two windows 601, each having an outer frame 604 and an opening frame 605. The outer frames 604 are placed against one another and connected to one another by means of a connecting element 699. The opening frames are tiltable and/or pivotable in accordance with the arrows 609. The windows 601 are arranged in mirror symmetry relative to the mirror plane 698. As an alternative, it is also possible for the windows not to be arranged in mirror symmetry, having different wood widths or window combinations with and without casement profiles etc., for example.

Profiled covers 615 are arranged on both outer frames 604, as shown in FIGS. 2 and 6, unless otherwise stated in the description of FIG. 8. Accordingly, attention is drawn to the description relating thereto. The profiled covers 615 are likewise arranged in mirror symmetry relative to the mirror plane 698. As with the preceding figures above, they are connected to the respective outer frame 604 and their fastening elements 624 face one another. Here, the fastening elements 624 form mutually facing pockets which are open in a lateral direction and into which an outer cladding 690 can be inserted, see FIG. 8. A filling and/or insulating material 691 is optionally arranged between the outer cladding 690 and the profiled cover 615 or the outer frame 604.

FIG. 9 shows two windows 701, each having an outer frame 704 and an opening frame 705. The outer frames 704 are placed against one another and connected to one another by means of a connecting element 799. The opening frames 705 are tiltable and/or pivotable in accordance with the arrow 709. The windows 701 are arranged in mirror symmetry relative to the mirror plane 798.

Profiled covers 715 are arranged on both outer frames 704, as shown in FIGS. 1 and 7. Accordingly, attention is drawn to the description relating thereto, unless there is a separate description relating to FIG. 9. The profiled covers 715 are likewise arranged in mirror symmetry relative to the mirror plane 798. As with the preceding figures above, they are connected to the respective outer frame 704 and their fastening elements 724 face one another. Here, the fastening elements 724 form open pockets which are aligned so as to be open in a normal direction 722 and into which an outer cladding 790 can be inserted, see FIG. 9. A filling and/or insulating material 791 is optionally arranged between the outer cladding 790 and the profiled cover 715 or the outer frame 704. The outer cladding 790 is preferably formed by two flat profiles 780 aligned in the normal direction 722 and one flat profile 781 aligned in the lateral direction 721, which are connected to one another at their contact points by means of corner profiles 782.

FIGS. 8 and 9 each show an embodiment example in which two outer frames and two opening frames of adjacently arranged windows are covered by means of an outer cladding. The outer frame profiles of the two outer frames abut and are coupled to one another.

FIGS. 10 and 11 show further alternatives thereto, in which the outer frame profiles of the two windows do not rest directly against one another; instead, at least one further profile or one further structural element is arranged between the two outer frames.

In FIG. 10, at least one further structural element 650 is accordingly arranged between the two outer frames 604, said element being sealed with respect to the outer frames by means of the sealing elements 651 and the free space situated in between being insulated by means of the insulating elements 652.

In FIG. 11, at least one further structural element 750 is furthermore arranged between the two outer frames 704, said element being sealed with respect to the outer frames by means of the sealing elements 751 and the free space situated in between being insulated by means of the insulating elements 752.

The further structural element can be a wall section, a wooden pillar or a façade element or the like, for example. If a pane of glass is used as the outer cladding, it is possible to achieve the appearance of virtually continuous glass.

Like FIG. 9, FIG. 11 additionally shows a corner profile. As a result, the outer cover can be composed of sheet-like material and does not have to be edged. Furthermore, it is possible to adapt the thickness of the thermal insulation to requirements, for example, e.g. to legal requirements.

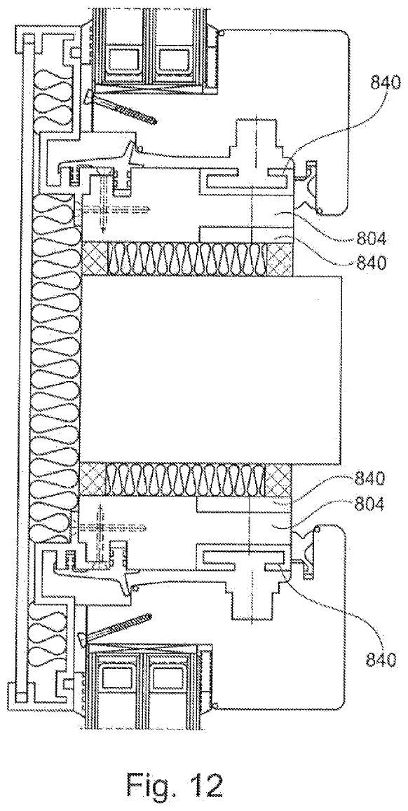

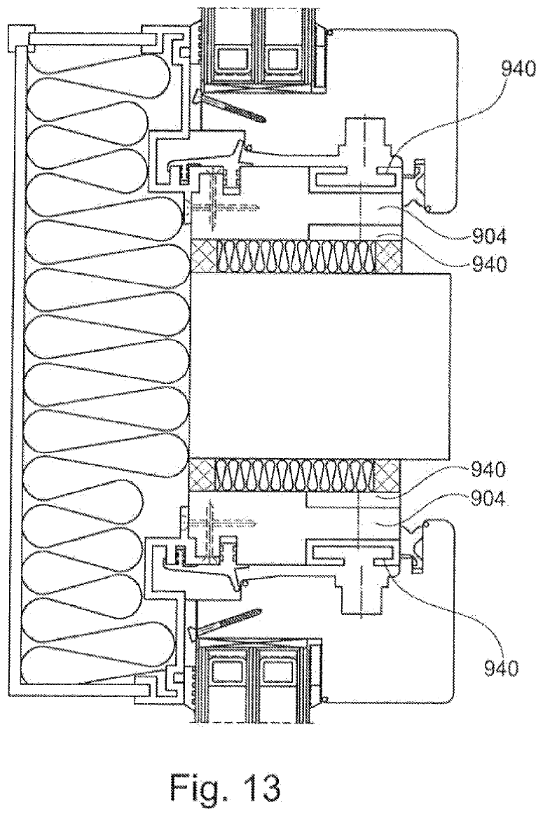

FIGS. 12 and 13 show further alternative embodiment examples, in which, as in FIGS. 10 and 11, an assembly of two windows with a further structural element arranged in between can be seen. To reduce the frame width, however, the outer frames 804, 904 are reduced in width relative to the designs in FIGS. 10 and 11.

The visible width of the outer frame is thereby kept as small as possible. This ensures a minimum visible width of the window frame, especially in the case of coupled windows like those shown in FIGS. 8 and 9 or in the case of windows with a further structural element between the two outer frames. However, the small visible width of the outer frame may have the effect of greatly reducing the fastening region for the window fittings. In order to establish the required strength of the outer frame, static additional elements 840, 940 can be provided on the outer frame 804, 904. These additional elements 840, 940 can be situated at various points on the outer frame 804, 904, e.g. in the direction of the structural element. As an option, it is also possible for an additional element of this kind to be provided on an opening frame, said element increasing the stability of the opening frame. It is preferred here if the additional element is a reinforcing profile, which is preferably composed of metal or the like and is connected to the outer frame and/or to the opening frame and, in particular, is inserted into a recess in the outer frame and/or in the opening frame.

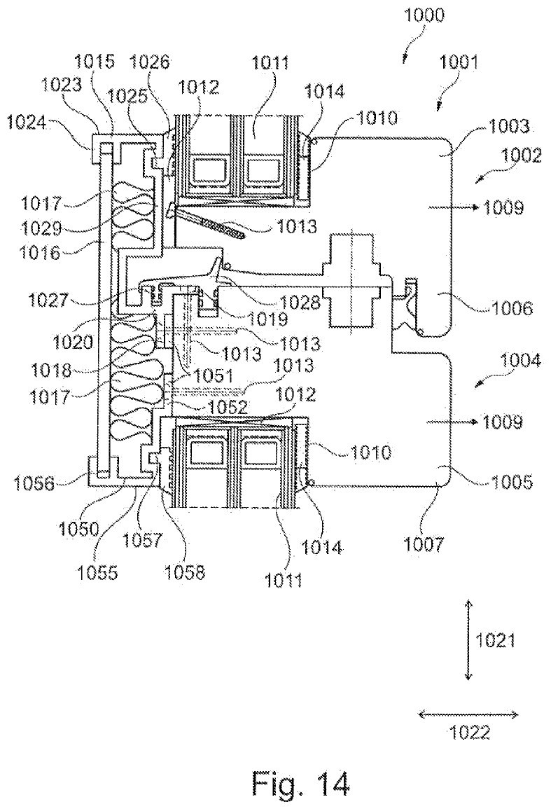

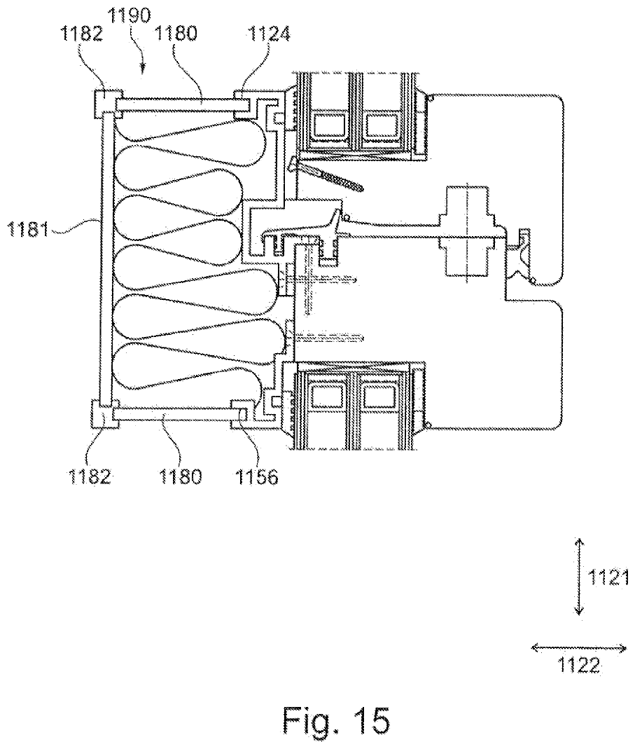

FIGS. 14 and 15 show two further embodiment examples of windows having two adjacently arranged window casements without fixed intermediate pillars in the astragal region.

FIG. 14 shows a view of a partial section through another cover assembly 1000 according to the invention of a window 1001, in particular in an opening (not illustrated), in particular of a building, in accordance with another embodiment example of the present invention.

The window 1001 has a first window casement 1002 having an opening frame 1003 and a further window casement 1004 with a further opening frame 1005, wherein the two opening frames 1003, 1005 are shown in the astragal region without an intermediate pillar arranged in between.

A surrounding outer frame is typically arranged around the opening frames 1003, 1005 shown, but this outer frame is not shown. The window 1001 has a first opening frame 1003, which is arranged movably, e.g. in particular tiltably and/or pivotably and/or slidably, in particular in an outer frame that is not shown. The window 1001 furthermore has a second opening frame 1005, which is likewise arranged movably, e.g. in particular tiltably and/or pivotably and/or slidably, in particular in the outer frame that is not shown.

In the present embodiment example in FIG. 14, it is assumed, without restricting the general scope thereof, that the outer frame (not illustrated) is of fixed design or, alternatively, is omitted and the respective opening frame 1003, 1005 can be moved to the right, see the arrows 1009. The opening frame 1003, 1005 is in each case formed by opening frame profiles 1006, 1007, which are connected to one another and each form the corresponding opening frame 1003, 1005 as a frame-type element.

It is advantageous if the opening frame profiles 1006, 1007 of the opening frame 1003, 1005 are made of wood, plastic, metal, such as aluminum or the like, or of any combination of such materials or from mixtures of such materials in the form of hybrid or composite materials. Reinforcing additions, such as fiber components, cores etc., may also be provided.

The opening frame 1003, 1005 in each case has a recess 1010, which is open on one side for insertion of a pane 1011, which is held in the recess 1010 by means of the holding element 1012. For this purpose, the holding element 1012 is screwed to the opening frame 1003, for example, see the screw 1013, or is adhesively bonded to the opening frame 1005. The respective pane 1011 is arranged in a manner sealed with respect to the respective opening frame 1003, 1005, for which purpose a seal 1014 is in each case provided between the respective pane 1011 and the respective opening frame 1003, 1005.

Arranged on the outside of the opening frame 1005 is a first profiled cover 1015 and a second profiled cover 1050, which are each firmly connected to the opening frame 1005 and extend laterally from the opening frame 1005. In this case, the first profiled cover 1015 also extends via the opening frame 1003 as far as an edge region of the pane 1011, which is likewise covered.

The second profiled cover 1050, which is arranged at a distance from the first profiled cover 1015, also extends in the lateral direction toward the other pane 1011, which it likewise covers in an edge region.

The first profiled cover 1015 and the second profiled cover 1050 are firmly connected to the opening frame 1005, see the screws 1013. In an alternative embodiment that is not shown, the first profiled cover 1015 and the second profiled cover 1050 are embodied by a single profiled cover, in which an interspace between the first profiled cover 1015 and the second profiled cover 1050 in the opening frame 1005 is closed by this single profiled cover.

It can be seen in FIG. 14 that an external outer cladding 1016, e.g. a board material or the like, is arranged between the first profiled cover 1015 and the second profiled cover 1050. This outer cladding 1016 substantially covers both profiled cover 1015 and profiled cover 1050. Here, the outer cladding 1016 is preferably designed as a board. Optional thermal insulation 1017 is arranged between the outer cladding 1016 and the profiled cover 1015 and 1050, respectively.

The first profiled cover 1015 is configured in such a way that it has at least one fastening element 1018 in one of its two lateral end regions 1020, in the present embodiment example the first profiled cover 1015 has two fastening elements 1018, 1019 in the lateral end region 1020. However, it is also possible for more than two such fastening elements 1018, 1019 to be provided. The fastening element or fastening elements 1018, 1019 are used to fasten the first profiled cover 1015 on the opening frame 1005. FIG. 14 shows that fastening element 1018 is a web which extends in the lateral direction 1021 and which is screwed to the opening frame 1005 by means of a screw 1013. Figure also shows that fastening element 1019 is a web which extends in the normal direction 1022 and which is screwed to the opening frame 1005 by means of a screw 1013.

Here, the lateral direction 1021 is defined as the direction which is parallel to the plane of the panes 1011. The normal direction 1022 is defined as the direction which is aligned perpendicularly to the plane of the panes 1011.

In this case, fastening element 1018 is perpendicular to fasting element 1019, thus enabling the two fastening elements 1018, 1019 to be screwed on in one corner of the opening frame 1005. As an alternative to screw fastening, it is also possible to use some other connection method, e.g. riveting, clipping or adhesive bonding etc. For this purpose, correspondingly suitable connection elements can be used instead of the screws illustrated.

A further, third fastening element 1024, which is used to fasten the outer cladding 1016, for example, is provided in the other lateral end region 1023 of the first profiled cover 1015. Here, the third fastening element 1024 is designed as a pocket, which is of open design on one side in the lateral direction 1021. An element or section of the outer cladding 1016 or a fastening element, for example, can engage in this pocket in order to fasten the outer cladding 1016. The pocket is preferably a groove in the first profiled cover 1015.

The second profiled cover 1050 is configured in such a way that it has at least one fastening element 1052 in one of its two lateral end regions 1051. In the present embodiment example, the first profiled cover 1015 also has just one fastening element 1052 in the lateral end region 1051. However, it is also possible for more than one such fastening element 1052 to be provided. The fastening element 1052 is used to fasten the second profiled cover 1050 on the opening frame 1005. FIG. 14 shows that fastening element 1052 is a web which extends in the lateral direction 1021 and which is screwed to the opening frame 1005 by means of a screw 1013. As an option, it is furthermore also possible for a web which extends in the normal direction 1022 and which could be screwed to the opening frame 1005 by means of a screw 1013 to be provided as a further fastening element. As an alternative to screw fastening, it is also possible to use some other connection method, e.g. riveting, clipping or adhesive bonding etc. For this purpose, correspondingly suitable connection elements can be used instead of the screws illustrated.

A further fastening element 1056, which is used to fasten the outer cladding 1016, for example, is provided in the other lateral end region 1055 of the second profiled cover 1050. Here, the further fastening element 1056 is designed as a pocket, which is of open design on one side in the lateral direction 1021. An element or section of the outer cladding 1016 or a fastening element, for example, can engage in this pocket in order to fasten the outer cladding 1016. The pocket is preferably a groove in the first profiled cover 1015. The pockets 1056 and 1024 are situated with their open sides opposite one another and accommodate the sheet-like outer cladding 1016 at the edge.

A fifth fastening element 1027, which is used to fasten a sealing element 1028, for example, is furthermore provided in the first lateral end region 1020 of the profiled cover 1015. Here, the fifth fastening element 1027 is designed as a pocket, which is of open design on one side in the lateral direction 1021 and is of open design toward the opening frame 1003. An element of the sealing element 1028, for example, can engage in this pocket in order to fasten the sealing element 1028 on the profiled cover 1015. This pocket is preferably a groove in the profiled cover 1015. The sealing element 1028 serves to rest against the opening frame 1003 and against the opening frame 1005 when the window is closed.

A fourth fastening element 1025, which is used to fasten a sealing element 1026, for example, is provided adjacent to the third fastening element 1024. Here, the fourth fastening element 1025 is designed as a pocket, which is of open design on one side in the normal direction 1022 and is of open design toward the pane 1011. An element of the sealing element 1026, for example, can engage in this pocket in order to fasten the sealing element 1026 on the profiled cover 1015. This pocket is preferably a groove in the profiled cover 1015. The sealing element 1026 serves to rest against the pane 1011 when the window is closed.

A straight section 1029 of the profiled cover 1015, which is arranged opposite the holding element 1012 and covers the latter, is provided between the fourth fastening element 1025 and the fifth fastening element 1027.

The second profiled cover 1050 has a further fastening element 1057, which is used to fasten a sealing element 1058, for example. Here, the fourth fastening element 1057 is designed as a pocket, which is of open design on one side in the normal direction 1022 and is of open design toward the pane 1011. An element of the sealing element 1058, for example, can engage in this pocket in order to fasten the sealing element 1058 on the profiled cover 1050. This pocket is preferably a groove in the profiled cover 1050. The sealing element 1058 serves to rest against the pane 1011 when the window is closed.

The outer claddings 416 and 451, together with the profiled cover 415, cover the entire window frame with the outer frame 404 and the opening frame 405 when viewed from the outside, with the result that, when viewed from the outside, the building 403 is provided with windows which are installed without visible frames.

FIG. 15 shows another embodiment example, in which, as in FIG. 9, the outer cladding consists not of a flat element but of an assembled element. For this purpose, pockets 1124, 1156 are of open design in the normal direction and receive an outer cladding 1190. The outer cladding 1190 is preferably formed by two flat profiles 1180 aligned in the normal direction 1122 and one flat profile 1181 aligned in the lateral direction 1121, which are connected to one another at their contact points by means of corner profiles 1182. In other respects, attention is drawn as regards the other details to the description of FIG. 14.

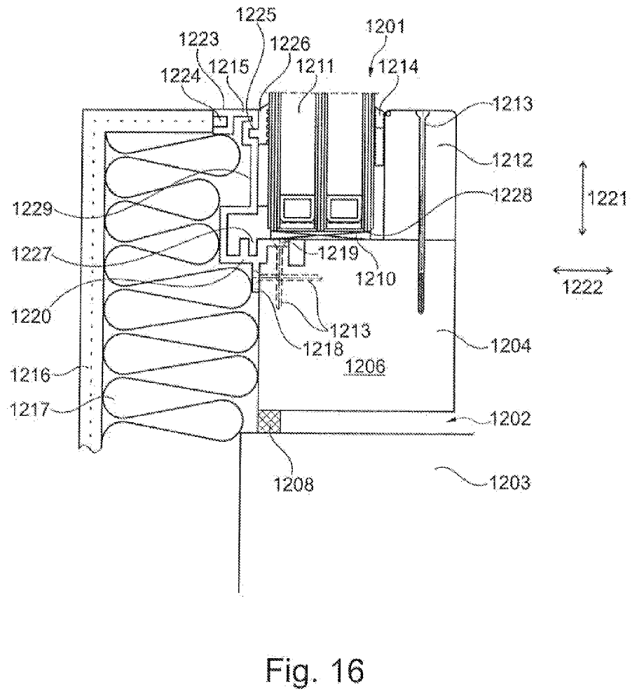

FIG. 16 shows a view of a partial section through a cover assembly of a window 1201 in an opening 1202, in particular of a building 1203, in accordance with a sixteenth embodiment example of the present invention. The window 1201 is shown as arranged in the opening 1202 of a building 1203. The window 1201 can also be arranged elsewhere without restricting the general scope. In FIG. 16, only part of the building 1203, of the opening 1202 and of the window 1201 can be seen of this assembly in the section.

The window 1201 has an outer frame 1204, which is arranged in the opening 1202 of the building 1203 and is connected in a fixed manner to the building 1203 in order to position the window 1201 in a sealed manner in the opening 1202 of the building 1203. To seal off the window 1201 with respect to the building 1203, a sealing element 1208 is provided, which rests in a sealing manner both against the outer frame 1204 and against the housing 1203 in an interspace between the outer frame 1204 and the housing 1203. The outer frame 1204 is formed by outer frame profiles 1206, which are connected to one another and form the outer frame 1204 as a frame-type element.

In this embodiment example, the window 1201 does not have an opening frame, which is arranged in the outer frame. In the present embodiment example in FIG. 16, it is assumed, without restricting the general scope, that the outer frame 1204 is of fixed design and cannot be opened.

It is advantageous if the outer frame profiles 1206 of the outer frame 1204 are made of wood, plastic, metal, such as aluminum or the like, or of any combination of such materials or from mixtures of such materials in the form of hybrid or composite materials. Reinforcing additions, such as fiber components, cores etc., may also be provided.

The outer frame 1204 has a recess 1210 for insertion of a pane 1211, which is held in the recess 1210 by means of the holding element 1212. For this purpose, the holding element 1212 is screwed to the outer frame 1204, for example, see the screw 1213. The pane 1211 is arranged in a manner sealed with respect to the outer frame 1204, for which purpose a seal 1214 is provided between the pane 1211 and the outer frame 1204.

Arranged on the outside of the outer frame 1204 is a profiled cover 1215, which is firmly connected to the outer frame 1204 and extends laterally from the outer frame 1204 to an edge region of the pane 1211 and likewise covers this edge region of the pane 1211.

Visible in FIG. 16 is part of an outer cladding 1216, e.g. plaster, board material or the like, which overlaps the top surface of the profiled cover 1215, in particular preferably the entire top surface of the profiled cover 1215. The outer cladding 1216 also preferably contains optional thermal insulation 1217. In this case, the thickness of the thermal insulation 1217 and optionally also the material of the thermal insulation can preferably be selected independently of the profiled cover 1215 used.

The profiled cover 1215 is configured in such a way that it has at least one fastening element 1218 in one of its two lateral end regions 1220, in the present embodiment example the profiled cover 1215 has two fastening elements 1218, 1219 in the lateral end region 1220. However, it is also possible for more than two such fastening elements 1218, 1219 to be provided. The fastening element or fastening elements 1218, 1219 are used to fasten the profiled cover 1215 on the outer frame 1204. FIG. 16 shows that fastening element 1218 is a web which extends in the lateral direction and which is screwed to the outer frame by means of a screw 1213. FIG. 16 also shows that fastening element 1219 is a web which extends in the normal direction and which is screwed to the outer frame 1204 by means of a screw 1213.

Here, the lateral direction 1221 is defined as the direction which is parallel to the plane of the pane 1211. The normal direction 1222 is defined as the direction which is aligned perpendicularly, i.e. normally, to the plane of the pane 1211.

In this case, fastening element 1218 is perpendicular to fasting element 1219, thus enabling the two fastening elements 1218, 1219 to be screwed on in one corner of the outer frame 1204. As an alternative to screw fastening, it is also possible to use some other connection method, e.g. riveting, clipping or adhesive bonding etc. For this purpose, correspondingly suitable connection elements can be used instead of the screws 1213 illustrated.

A further, third fastening element 1224, which is used to fasten the outer cladding 1216, for example, is provided in the other lateral end region 1223. Here, the third fastening element 1224 is designed as a pocket, which is of open design on one side in the normal direction 1222. An element of the outer cladding 1216 or a fastening element, for example, can engage in this pocket in order to fasten the outer cladding 1216. The pocket is preferably a groove in the profiled cover 1215.

A fourth fastening element 1225, which is used to fasten a sealing element 1226, for example, is provided adjacent to the third fastening element 1224. Here, the fourth fastening element 1225 is designed as a pocket, which is of open design on one side in the normal direction 1222 and is of open design toward the pane 1211. An element of the sealing element 1226, for example, can engage in this pocket in order to fasten the sealing element 1226 on the profiled cover 1215. This pocket is preferably a groove in the profiled cover 1215. The sealing element 1226 serves to rest against the pane 1211.

A fifth fastening element 1227, which can be used to fasten a sealing element 1228, for example, is furthermore provided in the first lateral end region 1220. However, this sealing element is optional and, as an alternative, can also be fastened elsewhere. Here, the fifth fastening element 1227 is designed as a pocket, which is of open design on one side in the lateral direction 1221 and is of open design toward the pane 1211. An element of a sealing element, for example, can engage in this pocket in order to fasten the sealing element on the profiled cover 1215, although this is not shown. Instead, a sealing element 1228 is arranged on the outer frame 1204 and between the outer frame 1204 and the pane 1211. This sealing element 1228 is preferably adhesively bonded to the outer frame 1204 and/or to the pane 1211.

A straight section 1229 of the profiled cover 1215 is provided between the fourth fastening element 1225 and the fifth fastening element 1227.

The outer cladding 1216, together with the profiled cover 1215, cover the entire window frame with the outer frame 1204 when viewed from the outside, with the result that, when viewed from the outside, the building 1203 is provided with windows which are installed without visible frames.

### LIST OF REFERENCE SIGNS

1 window
2 opening
3 building
4 outer frame
5 opening frame
6 outer frame profile
7 opening frame profile
8 sealing element
9 arrow
10 recess
11 pane
12 holding element
13 screw
14 seal
15 profiled cover
16 outer cladding
17 thermal insulation
18 first fastening element
19 second fastening element
20 end region
21 lateral direction
22 normal direction
23 end region
24 third fastening element
25 fourth fastening element
26 sealing element
27 fifth fastening element
28 sealing element
29 section
50 slot, hole
51 slot, hole
100 cover assembly
101 cover assembly
102 cover assembly
103 cover assembly
104 cover assembly
116 outer cladding
117 end profile
118 laterally projecting web
119 laterally projecting web
120 central web
124 third fastening element
216 external outer cladding
217 L-shaped end profile
250 drainage device
251 tube
252 hole
316 external outer cladding
317 double-L-shaped end profile
399 cover assembly
401 window
402 opening
403 building
404 outer frame
405 opening frame
406 outer frame profiles
407 opening frame profiles
408 sealing element
409 arrow
410 recess
411 pane
412 holding element
413 screw
414 seal
415 first profile cover
416 external outer cladding
417 optional thermal insulation
418 first fastening element
419 second fastening element
420 lateral end region
421 lateral direction
422 normal direction
423 lateral end region
424 third fastening element
425 fourth fastening element
427 fifth fastening element
428 sealing element
429 straight section
450 fastening profile
451 outer cladding
452 optional thermal insulation
460 laterally extending first arm
461 normally extending second arm
462 fastening element
498 cover assembly
550 fastening profile
551 outer cladding
552 optional thermal insulation
560 laterally extending first arm
562 fastening element
601 window
604 outer frame
605 opening frame
609 arrow
615 profiled cover
624 fastening element
650 further structural element
651 sealing element
652 insulating element
690 outer cladding
698 mirror plane
699 connecting element
701 window
704 outer frame
705 opening frame
709 arrow
715 profiled cover
721 lateral direction
722 normal direction
724 fastening element
750 further structural element
751 sealing element
752 insulating element
780 flat profile aligned in normal direction 722
781 flat profile aligned in lateral direction 721
782 corner profile
790 outer cladding
791 insulating material
798 mirror plane
799 connecting element
804 outer frame
840 additional element
940 additional element
904 outer frame
1000 cover assembly
1001 window
1002 first window casement
1003 opening frame
1004 further window casement
1005 further opening frame
1006 opening frame profile
1007 opening frame profile
1009 arrows
1010 recess
1011 pane
1012 holding element
1013 screw
1014 seal
1015 first profiled cover
1016 external outer cladding
1017 optional thermal insulation
1018 fastening element
1019 fastening element
1020 lateral end region
1021 lateral direction
1022 normal direction
1024 fastening element or pocket
1025 fourth fastening element
1026 sealing element
1027 fifth fastening element
1028 sealing element
1029 straight section
1050 second profiled cover
1051 lateral end region
1052 fastening element
1055 lateral end region
1056 further fastening element or pocket
1057 fourth fastening element or pocket
1058 sealing element
1122 normal direction
1124 pockets
1156 pockets
1180 flat profile aligned in normal direction 1122
1181 flat profile aligned in lateral direction 1121
1182 corner profile
1190 outer cladding
1201 window
1202 opening
1203 building
1204 outer frame
1206 outer frame profile
1208 sealing element
1210 recess
1211 pane
1212 holding element
1213 screw
1214 seal
1215 profiled cover
1216 outer cover
1217 thermal insulation
1218 fastening element
1219 fastening element
1220 lateral end region
1221 lateral direction
1222 normal direction
1223 lateral end region
1224 fastening element
1225 fastening element
1226 sealing element
1227 fastening element
1228 sealing element
1229 section

1. A cover assembly for covering an outer frame, an outer frame and an opening frame, or two opening frames of at least one window, having a first profiled cover, which can be fastened on the outer frame or on one of the opening frames and by means of which an outer cladding can be fastened, wherein the profiled cover at least partly covers the outer frame, the outer frame and the at least one opening frame, or the two opening frames, wherein the outer cladding connected to the profiled cover covers the profiled cover and the outer frame or the outer frame and the opening frame or the two opening frames.

2. The cover assembly as claimed in claim 1, wherein the profiled cover has at least one first fastening element and optionally one second fastening element, by means of which the profiled cover can be connected to an outer frame or to an opening frame.

3. The cover assembly as claimed in claim 2, wherein the first fastening element and optionally the second fastening element is or are arranged on a first lateral end region of the profiled cover.

4. The cover assembly as claimed in claim 1, wherein the profiled cover has a third fastening element, by means of which the outer cladding can be connected to the profiled cover.

5. The cover assembly as claimed in claim 4, wherein the third fastening element is arranged on a second lateral end region of the profiled cover.

6. The cover assembly as claimed in claim 1, wherein the profiled cover has a fourth fastening element and optionally a fifth fastening element, by means of which a first sealing element and optionally a second sealing element can be connected to the profiled cover.

7. The cover assembly as claimed in claim 1, wherein a fastening profile and/or a second profiled cover are/is furthermore provided.

8. The cover assembly as claimed in claim 7, wherein the fastening profile and/or the second profiled cover have/has at least one first fastening element and one second fastening element.

9. The cover assembly as claimed in claim 8, wherein the first fastening element of the fastening profile and/or of the second profiled cover serves to connect the fastening profile and/or the second profiled cover to an outer frame or to an opening frame.

10. The cover assembly as claimed in claim 8, wherein the second fastening element of the fastening profile and/or of the second profiled cover serves to connect an outer cladding to the fastening profile and/or to the second profiled cover.

11. The cover assembly as claimed in claim 1, wherein at least one web and/or at least one pocket is provided as at least one of the fastening elements.

12. The cover assembly as claimed in claim 1, wherein the at least one web projects in a lateral direction or in a normal direction, wherein the lateral direction lies in a plane which is defined by the window surface of the window and the normal direction is aligned perpendicularly to the window surface.

13. The cover assembly as claimed in claim 1, wherein the window surface is defined by a pane or by an insert which is arranged in an outer frame or in an opening frame.

14. The cover assembly as claimed in claim 1, wherein the at least one pocket is of open design in a lateral direction or in a normal direction.

15. The cover assembly as claimed in claim 1, wherein a filling and/or insulating material is arranged between the outer cladding and the outer frame and/or the opening frame and/or the profiled cover and/or the fastening profile.

16. The cover assembly as claimed in claim 1, wherein the outer cladding, has an element which is aligned substantially normally to the window surface and by means of the extent of which the space for a filling and/or insulating material can be specified.

17. The cover assembly as claimed, in particular, in claim 1, wherein the outer cladding is composed of one of the following materials or mixtures or compositions thereof, such as metal, aluminum, plastic, wood and/or glass etc.

18. The cover assembly as claimed, in particular, in claim 1, wherein the profiled cover has openings, such as holes or slots or the like, for draining water, such as condensate and/or rainwater.

19. A window, in particular a window having an outer frame and/or, in particular, having at least one opening frame, wherein a cover assembly as claimed in claim 1 is provided.

20. The window as claimed, in particular, in claim 19, wherein a drainage device is integrated into the outer cladding and/or into at least one profiled cover in order to enable water that arises to be drained out of the outer cladding and/or out of the at least one profiled cover.

21. The window as claimed in claim 20, wherein the drainage device has at least one tube, which is let into the outer cladding and/or into at least one profiled cover and carries water out of the outer cladding and/or out of the at least one profiled cover.

22. The window, in particular as claimed in claim 1, in particular a window having an outer frame and/or, in particular, having at least one opening frame, wherein an additional element is inserted into or connected to the outer frame and/or the opening frame in order to increase the stability of the outer frame and/or of the opening frame.

23. The window, in particular as claimed in claim 22, wherein the additional element is a reinforcing profile, which is preferably composed of metal and is connected to the outer frame and/or to the opening frame and, in particular, is inserted into a recess in the outer frame and/or in the opening frame.
